(19) United States
(12) Patent Application Publication
(10) Pub. No.: US 2026/0249328 A1
(43) Pub. Date: Aug. 27, 2026

(54) CLEANING APPLIANCE

(71) Applicant: Alfred Kärcher SE & Co. KG, Winnenden (DE)

(72) Inventors: Lars ECKSTEIN, Winnenden (DE); Rainer KURMANN, Winnenden (DE)

(21) Appl. No.: 19/651,329

(22) Filed: Apr. 17, 2026

Related U.S. Application Data
(63) Continuation of application No. PCT/EP2024/079427, filed on Oct. 17, 2024.

(30) Foreign Application Priority Data
Oct. 20, 2023 (DE) 10 2023 128 897.0

(51) Int. Cl. B08B 5/02; B24C 1/00; C01B 32/55

(52) U.S. Cl. CPC B08B 5/02; B24C 1/003; C01B 32/55

(57) ABSTRACT

A cleaning appliance for blasting surfaces is disclosed and includes an apparatus for producing CO₂ pellets that includes a compaction device for compacting CO₂ snow to form the CO₂ pellets, wherein the compaction device includes an expansion device for producing CO₂ snow by expanding liquid or pressurized CO₂, and wherein the cleaning appliance includes a CO₂ connection line fluidically connected to the expansion chamber inlet for supplying the liquid or pressurized CO₂ to the expansion device, wherein the cleaning appliance includes a passive cooling device for cooling liquid or pressurized CO₂ flowing through the CO₂ connection line, wherein the cooling device includes at least one heat exchanger, which includes a cooling channel and a CO₂ channel forming a connection line portion of the CO₂ connection line, wherein the cooling channel is surrounded at least in sections by the CO₂ channel in the circumferential direction relative to the direction of extent.

### CROSS-REFERENCE TO RELATED APPLICATIONS

This application is a continuation of international application number PCT/EP2024/079427, filed on October 17, 2024, and claims the benefit of German application number 102023128 897.0, filed on October 20, 2023, which are incorporated herein by reference in their entirety and for all purposes.

### FIELD OF THE INVENTION

The invention relates to cleaning appliances for blasting surfaces to be treated with a mixed stream of a pressurized gas and CO₂ pellets generally, and more specifically to a cleaning appliance for blasting surfaces to be treated with a mixed stream of a pressurized gas and CO₂ pellets, comprising an apparatus for producing CO₂ pellets from liquid or pressurized CO₂, wherein the apparatus comprises a compaction device for compacting CO₂ snow to form the CO₂ pellets, wherein the compaction device comprises an expansion device for producing CO₂ snow by expanding liquid or pressurized CO₂, wherein the expansion device comprises an expansion chamber having an expansion chamber inlet, and wherein the cleaning appliance comprises a CO₂ connection line fluidically connected to the expansion chamber inlet for supplying the liquid or pressurized CO₂ to the expansion device, wherein the cleaning appliance comprises a passive cooling device, in particular in the form of a counterflow cooling device, for cooling liquid or pressurized CO₂ flowing through the CO₂ connection line, wherein the cooling device comprises at least one heat exchanger, which comprises a cooling channel defining a direction of extent and comprises a CO₂ channel, wherein the CO₂ channel forms a connection line portion of the CO₂ connection line.

The invention further relates to methods for cooling liquid or pressurized CO₂ when supplying to an expansion device generally, and more specifically to a method for cooling liquid or pressurized CO₂ when supplying to an expansion device, said expansion device being configured to produce CO₂ snow by expanding the liquid or pressurized CO₂, of a cleaning appliance for blasting surfaces to be treated with a mixed stream of a pressurized gas and CO₂ pellets, in particular of a cleaning appliance as described above, wherein the cleaning appliance comprises an apparatus for producing CO₂ pellets from the liquid or pressurized CO₂, wherein the apparatus comprises a compaction device for compacting CO₂ snow to form the CO₂ pellets, wherein the compaction device comprises the expansion device, wherein the liquid or pressurized CO₂ is passively cooled, in particular in counterflow, with gaseous CO₂ exhaust gas that arises during the production of the CO₂ snow and the CO₂ pellets.

### BACKGROUND OF THE INVENTION

A cleaning appliance of the kind described at the outset is known, e.g., from WO 2015/079022 A1. With this cleaning appliance, it is possible to produce CO₂ pellets, i.e., so-called dry ice pellets, from liquid CO₂.

A problem with known cleaning appliances of that kind is, in particular, the limited yield of CO₂ pellets producible from a predetermined amount of liquid CO₂.

DE 10 2004 018 133 B3 describes an arrangement for creating a dry ice particle jet and a use thereof. WO 2022/011901 A1 discloses an exhaust gas treatment system for a CO₂ pellet cleaning machine. A device for producing a jet of dry ice particles is described in DE 10 2007 046 791 B3. A device for producing a CO₂ snow jet is disclosed in DE 2019 108 289 A1. DE 44 02 247 A1 discloses surface cleaning with argon. Methods and devices for producing supercooled carbon dioxide snow are described in DE 10 2014 018 981 A1.

### SUMMARY OF THE INVENTION

In a first aspect of the invention, a cleaning appliance for blasting surfaces to be treated with a mixed stream of a pressurized gas and CO₂ pellets, comprises an apparatus for producing CO₂ pellets from liquid or pressurized CO₂. The apparatus comprises a compaction device for compacting CO₂ snow to form the CO₂ pellets. The compaction device comprises an expansion device for producing CO₂ snow by expanding liquid or pressurized CO₂. The expansion device comprises an expansion chamber having an expansion chamber inlet, and the cleaning appliance comprises a CO₂ connection line fluidically connected to the expansion chamber inlet for supplying the liquid or pressurized CO₂ to the expansion device. The cleaning appliance comprises a passive cooling device, in particular in the form of a counterflow cooling device, for cooling liquid or pressurized CO₂ flowing through the CO₂ connection line. The cooling device comprises at least one heat exchanger, which comprises a cooling channel defining a direction of extent and comprises a CO₂ channel. The CO₂ channel forms a connection line portion of the CO₂ connection line. The cooling channel is surrounded at least in sections, in particular completely, by the CO₂ channel in the circumferential direction relative to the direction of extent.

In a second aspect of the invention, a method for cooling liquid or pressurized CO₂ when supplying to an expansion device is propose, said expansion device being configured to produce CO₂ snow by expanding the liquid or pressurized CO₂, of a cleaning appliance for blasting surfaces to be treated with a mixed stream of a pressurized gas and CO₂ pellets, in particular of a cleaning appliance as set forth in the first aspect of the invention. The cleaning appliance comprises an apparatus for producing CO₂ pellets from the liquid or pressurized CO₂. The apparatus comprises a compaction device for compacting CO₂ snow to form the CO₂ pellets. The compaction device comprises the expansion device. The liquid or pressurized CO₂ is cooled passively, in particular in counterflow, with gaseous CO₂ exhaust gas that arises during the production of the CO₂ snow and the CO₂ pellets. For cooling the liquid or pressurized CO₂, the CO₂ exhaust gas is conducted through a cooling channel, which is surrounded at least in sections, in particularly completely, by a CO₂ channel in the circumferential direction relative to a direction of extent defined thereby, which CO₂ channel is in thermal contact with the cooling channel and through which the liquid or pressurized CO₂ is guided.

### BRIEF DESCRIPTION OF THE DRAWING FIGURES

The subsequent description of preferred embodiments of the invention serves in conjunction with the drawings for further explanation:

FIG. 1 shows a schematic, partially broken total view of an embodiment of a cleaning appliance;

FIG. 2 shows a perspective, partially broken total view of the cleaning appliance from FIG. 1 without an outer housing;

FIG. 3 shows a further perspective view of the arrangement from FIG. 2;

FIG. 4 shows an enlarged perspective partial view of the arrangement from FIG. 3;

FIG. 5 shows a longitudinal section view of a first embodiment of a cooling device of the embodiment of a cleaning appliance schematically depicted in FIGS. 1 to 4 with a schematic depiction of a flow path of liquid and gaseous CO₂ through the cooling device;

FIG. 6 shows an enlarged view of the region A from FIG. 5;

FIG. 7 shows a longitudinal section view of a second embodiment of a cooling device;

FIG. 8 shows a longitudinal section view of a third embodiment of a cooling device;

FIG. 9 shows a schematic partial longitudinal section view of a fourth embodiment of a cooling device;

FIG. 10 shows a cross section view along line 10-10 in FIG. 6;

FIG. 11 shows a schematic cross section view similar to FIG. 10 of a further embodiment of a heat exchanger;

FIG. 12 shows a schematic cross section view similar to FIG. 10 of a further embodiment of a heat exchanger;

FIG. 13 shows a schematic depiction of the structure of a further embodiment of a cleaning appliance.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

The present invention relates to a cleaning appliance for blasting surfaces to be treated with a mixed stream of a pressurized gas and CO₂ pellets, comprising an apparatus for producing CO₂ pellets from liquid or pressurized CO₂, wherein the apparatus comprises a compaction device for compacting CO₂ snow to form the CO₂ pellets, wherein the compaction device comprises an expansion device for producing CO₂ snow by expanding liquid or pressurized CO₂, wherein the expansion device comprises an expansion chamber having an expansion chamber inlet, and wherein the cleaning appliance comprises a CO₂ connection line fluidically connected to the expansion chamber inlet for supplying the liquid or pressurized CO₂ to the expansion device, wherein the cleaning appliance comprises a passive cooling device, in particular in the form of a counterflow cooling device, for cooling liquid or pressurized CO₂ flowing through the CO₂ connection line, wherein the cooling device comprises at least one heat exchanger, which comprises a cooling channel defining a direction of extent and comprises a CO₂ channel, wherein the CO₂ channel forms a connection line portion of the CO₂ connection line, wherein the cooling channel is surrounded at least in sections, in particular completely, by the CO₂ channel in the circumferential direction relative to the direction of extent.

The further development proposed in accordance with the invention makes it possible, in particular, to improve the efficiency of the cleaning appliance, i.e. in particular to increase the yield of CO₂ pellets from a predetermined amount of liquid CO₂. By means of the cooling device, the starting product of the cleaning appliance, i.e., pressurized gaseous or liquid CO₂, can be cooled, namely in particular in counterflow or in parallel flow. In the case of parallel flow cooling, the fluids flow in the same direction and in the case of counterflow cooling in opposite directions through the at least one heat exchanger. The colder the liquid or pressurized gaseous CO₂ is, the more efficiently it can be used in the subsequent process. Thus, more CO₂ snow can be produced, the colder the liquid or pressurized gaseous CO₂ used for this is. Due to the special design, namely that the CO₂ channel surrounds the cooling channel in the circumferential direction at least in sections or partially, in particular completely, it is possible to significantly increase a contact area, namely a wall that separates the cooling channel and the CO₂ channel from one another. In particular, the structure of the cooling device or the heat exchanger can thus be significantly simplified. A helix-like, very complex design of the CO₂ channel like in DE 10 2022 109 526 A1, for example, can thus be foregone while having equal contact area. Rather, it is possible in principle to form the heat exchanger merely from two pipes with different diameters, the pipe with the smaller diameter delimiting the cooling channel and the CO₂ channel being formed between the two pipes in an annular space.

It is favorable if the cooling channel extends through the CO₂ channel in the direction of extent. In particular, the structure of the cooling device, i.e., the heat exchanger, can thus be simplified. As already mentioned, the heat exchanger can thus be formed by two simple straight pipe pieces, which are arranged concentrically to one another and in the interior define the cooling channel and an annular channel or annular space surrounding said cooling channel.

The CO₂ channel advantageously forms an annular space surrounding the cooling channel. This configuration enables, in particular, a simple structure of the heat exchanger, as already explained. A contact area between the CO₂ channel and the cooling channel can thus also be maximized.

In order to be able to optimally pre-cool the liquid or pressurized CO₂, it is favorable, in particular, if the cooling channel is delimited from the CO₂ channel by a heat exchange wall and is in thermal contact with said CO₂ channel. In particular when the heat exchange wall is made of a material with a high coefficient of thermal conductivity, for example a metallic material, CO₂ exhaust gas flowing through the cooling channel is thus able to optimally pre-cool the liquid or pressurized CO₂ flowing through the CO₂ channel.

The cooling device can be configured in a simple manner if the heat exchange wall is formed by a cooling channel pipe. In particular, the cooling channel pipe can then define the cooling channel, namely in its interior.

For a good heat exchange between the CO₂ exhaust gas that flows through the cooling channel and the liquid or pressurized CO₂ that flows through the CO₂ channel, it is favorable if the cooling channel pipe defining the cooling channel is made of a metallic material. In particular, the metallic material may be stainless steel or copper.

Further, it is advantageous if the CO₂ channel extends between the heat exchange wall and a CO₂ channel wall. The CO₂ channel can thus be configured, in particular, as an annular channel. The liquid or pressurized CO₂ flowing through the CO₂ channel is then in contact with the cooling channel along the heat exchange wall, such that an optimal heat exchange is able to take place in order to pre-cool the liquid or pressurized CO₂ by means of the CO₂ exhaust gas flowing through the cooling channel.

The heat exchanger can be formed in a simple manner if the CO₂ channel wall is formed by a CO₂ channel pipe. As already explained, the heat exchanger can thus be formed by two pipes, wherein the cooling channel pipe extends in the CO₂ channel pipe.

The CO₂ channel pipe delimiting the CO₂ channel on the outside is favorably made of a metallic or thermally insulating, non-metallic material. In particular, the required strength can thus be ensured to prevent the heat exchanger from bursting due to the liquid or pressurized CO₂ flowing through the CO₂ channel. A non-metallic, thermally insulating material has the advantage, in particular, of also using the CO₂ channel pipe to thermally insulate the heat exchanger.

The structure of the cleaning appliance is simplified further, in particular, due to the cooling channel extending rectilinearly and defining a cooling channel longitudinal axis. Thus, a rectilinearly extending cooling channel pipe can be used.

Moreover, it is advantageous if the CO₂ channel extends rectilinearly. In particular, it may extend concentrically to the cooling channel or be arranged or formed in this manner.

In accordance with a further preferred embodiment, provision may be made that the at least one heat exchanger, in particular the cooling channel, has a heat exchanger length in a range of about 0.5 m to about 2 m. In particular, it may have a heat exchanger length in a range of about 0.8 m to about 1.3 m. Further in particular, the heat exchanger length may be about 1 m. Heat exchangers with cooling channels that have lengths in the specified ranges can be produced in a simple manner. In addition, they have a size that is spatially feasible in a cleaning appliance of the kind described at the outset.

It is advantageous if the CO₂ connection line defines a first cross-sectional area outside of the heat exchanger, if the CO₂ channel defines a second cross-sectional area, and if the first cross-sectional area is smaller than the second cross-sectional area. This design makes it possible, in particular, to somewhat expand the liquid or pressurized CO₂ upon entry into the CO₂ channel. In this way, for one, a flow resistance in the CO₂ channel can be reduced and, for another, a separating surface between CO₂ channel and cooling channel can be made as large as possible in order to thus obtain a greatest possible contact area for heat exchange. Due to the expansion, a flow speed in the CO₂ channel decreases, resulting in a longer contact time when the liquid or pressurized CO₂ flows through the CO₂ channel. Furthermore, the diameter of the cooling channel pipe can be increased, the contact area between cooling channel and CO₂ channel thereby also increasing, which enables an improved heat exchange between the CO₂ exhaust gas and the liquid or pressurized CO₂.

It is favorable if a ratio of the first cross-sectional area and the second cross-sectional area is in a range of about 1:8 to about 1:2. In particular, the ratio may be in a range of about 1:6 to about 1:3. Further particularly, it may be about 1:4. Providing the ratios of the first and second cross-sectional areas in the specified ranges improves a heat exchange as already explained and thus an efficiency of the cleaning appliance overall. A yield of CO₂ pellets can thus be significantly increased. Improvements in the range of about 50% to about 60% compared to cleaning appliance of the kind described at the outset that have no heat exchanger are easily possible. Even compared to cleaning appliances with a heat exchanger, as described for example in DE 10 2022 109 526 A1, a further efficiency increase in a range of about 35% to about 40% is possible. CO₂ pellets can thus be formed in a resource-saving manner by means of the proposed heat exchanger.The ratio is selected, in particular, such that the liquid or pressurized CO₂ is able to expand only to such an extent that no CO₂ snow is formed in the CO₂ channel. A snow formation should be avoided in any case for optimal function of the cleaning appliance.

In accordance with a further preferred embodiment, provision may be made that the at least one heat exchanger has an inlet side and an outlet side, that the cooling channel comprises a cooling channel inlet and a cooling channel outlet, and that the cooling channel inlet is arranged or formed on the inlet side, and that the cooling channel outlet is arranged or formed on the outlet side. This configuration makes it possible, in particular, to guide the CO₂ exhaust gas that arises during the formation of the CO₂ pellets or the CO₂ snow through the cooling channel inlet into the cooling channel and from there through the cooling channel outlet.

A particularly simple and compact configuration of the heat exchanger can be achieved, in particular, by the cooling channel inlet and the cooling channel outlet being arranged or formed concentrically relative to the cooling channel longitudinal axis. In particular, hose connection pieces may be arranged or formed on free ends of the cooling channel pipe in order to connect the cooling channel inlet or the cooling channel outlet to an exhaust gas hose or an exhaust gas line, which conducts CO₂ exhaust gas from the compaction device to the cooling channel inlet and from the cooling channel outlet to a cleaning appliance exhaust gas outlet.

In order to enable, in particular, a counterflow cooling with the heat exchanger, it is advantageous if the CO₂ channel extends from the outlet side around the cooling channel to the inlet side. Liquid or pressurized CO₂ can thus be conducted from the outlet side of the heat exchanger through the CO₂ channel to the inlet side.

It is advantageous if the compaction device comprises a CO₂ exhaust gas outlet and if the CO₂ exhaust gas outlet is fluidically connected to the cooling channel inlet. The CO₂ exhaust gas created by sublimation during the formation of the CO₂ snow and the CO₂ pellets can thus be conducted, in particular entirely, from the compaction device to the heat exchanger in order to pre-cool the liquid or pressurized CO₂ in the CO₂ channel before it is discharged to the environment of the cleaning appliance.

It is favorable if a cross-sectional area of a first CO₂ exhaust gas line that fluidically connects the CO₂ exhaust gas outlet and the cooling channel inlet to one another corresponds to or substantially corresponds to a channel cross-sectional area of the cooling channel. A pressure buildup in the cooling channel can be prevented in this way. In particular, minimum cross sections of the second CO₂ exhaust gas line and the cooling channel can be predetermined to this end. The CO₂ exhaust gas should be able to flow as unhindered as possible from the CO₂ exhaust gas outlet to the CO₂ cleaning appliance exhaust gas outlet in order to prevent a counter-pressure from being able to build up when the liquid or pressurized CO₂ is expanded in the expansion device of the cleaning appliance. This would negatively affect an optimal yield in the production of CO₂ snow.

Further, it is advantageous if the CO₂ channel has a CO₂ channel length, if the at least one heat exchanger has a heat exchanger length that corresponds to a distance between the inlet side and the outlet side, and if a ratio between the CO₂ channel length and the heat exchanger length is about 1:1. This configuration enables a particularly simple structure of the heat exchanger. As already explained multiple times, two pipes can thus be used to define the CO₂ channel and the cooling channel.

In order to further improve the efficiency of the cleaning appliance, it is favorable if the at least one heat exchanger comprises a thermal insulation surrounding the CO₂ channel on an outer side facing away from the cooling channel. A heat absorption through the CO₂ channel pipe by the liquid or pressurized CO₂ upon flowing through the CO₂ channel can thus be minimized.

Preferably, the thermal insulation is arranged or formed on an outer side of the CO₂ channel wall facing away from the CO₂ channel. The heat exchanger can thus be thermally insulated in a simple manner overall and compactly.

In order to enable an unimpeded flow through the cooling channel or the CO₂ channel, it is advantageous if the cooling channel and the CO₂ channel are configured free of heat conducting elements. Introducing heat conducting elements in one or both channels leads to an increased constructive effort and to increased expenditure in the production of the heat exchanger of the cleaning appliance. In addition, heat conducting elements have an influence on the flow through the respective channels.

So that the flow through the cooling channel or the CO₂ channel is able to take place with as little flow losses as possible, it is favorable if the cooling channel and/or the CO₂ channel are delimited by macroscopically smooth wall surfaces.

In order to increase the dwell time of the CO₂ exhaust gas in the cooling channel, it is advantageous if the at least one heat exchanger comprises a turbulence device for generating a turbulent flow in a CO₂ gas stream flowing through the cooling channel.

A turbulent flow can be formed in a simple manner if the turbulence device comprises at least one turbulence element, which is arranged or formed in the cooling channel.

The production of a heat exchanger having a turbulence device can be achieved in a simple manner in particular by the at least one turbulence element being configured in the form of a helical projection. In particular, the helical projection may be configured in the form of a coil spring. For example, the turbulence device may be formed by a coil spring being inserted into the cooling channel in such a way that the coil spring is held in a clamping manner against an inner wall of the cooling channel pipe by a spring force exerted by said coil spring. However, a pretensioning of the coil spring is not necessary. It is sufficient if it is arranged, in particular if it lies, freely in the cooling channel.

For a permanently defined positioning of the turbulence device in the cooling channel, it is favorable if the turbulence device is connected to the cooling channel pipe in a force-locking and/or positive-locking and/or materially bonded manner.

In order to improve a cooling capacity for pre-cooling the liquid or pressurized CO₂, it is advantageous if the cooling device comprises two or more heat exchangers. In particular, said heat exchangers may be of identical or substantially identical configuration. In particular, two or more heat exchangers can be arranged in a cascading manner, i.e., in series, such that they are flowed through one after the other by the CO₂ exhaust gas stream in the one direction and are flowed through one after the other by the liquid or pressurized CO₂ in the other direction.

It is favorable if heat exchanger longitudinal axes of the two or more heat exchangers extend in parallel or substantially in parallel with one another. A particularly compact structure of the cooling device can thus be achieved.

Further, it is advantageous if the two or more heat exchangers are arranged in series one after the other in such a way that the cooling channels of the two or more heat exchangers are flowed through one after the other by a CO₂ exhaust gas stream.

Moreover, it is favorable if the cooling channel outlet of one of the two or more heat exchangers is fluidically connected to the cooling channel inlet of the heat exchanger arranged downstream in the flow direction of the CO₂ exhaust gas. In particular, such a connection can be established by way of a pipe section of semicircular or substantially semicircular configuration. Here, semicircular means, in particular, a redirection of the CO₂ exhaust gas stream by 180°.

In accordance with a further preferred embodiment, provision may be made that the CO₂ channel of the at least one heat exchanger comprises an inlet and an outlet, which are open pointing transversely, in particular perpendicularly, in the radial direction relative to a heat exchanger longitudinal axis of the at least one heat exchanger. This configuration makes it possible, in particular, in a simple manner to conduct the liquid or pressurized CO₂ in radial direction toward the cooling channel longitudinal axis into the CO₂ channel. In particular, it is thus possible to arrange the inlet and the cooling channel outlet not in parallel and, for another, to arrange the outlet and the cooling channel inlet also not in parallel. This simplifies and facilitates the assembly of the heat exchanger and the connection thereof to the CO₂ connection line on the one hand and to the CO₂ exhaust gas line on the other hand. Alternatively, it is also possible to provide inlet and outlet in the same direction as the cooling channel longitudinal axis. In the case of a cooling device with two heat exchangers, the longitudinal axes of which are oriented in parallel with one another, a connection of the two CO₂ channels can be established on the end faces by way of 180° bend. The two cooling channels of two heat exchangers can also be connected to one another in a similar manner.

The cleaning appliance can be configured in a simple and compact manner if the inlet and the outlet are oriented in parallel or substantially in parallel with one another.

The inlet and the outlet are preferably arranged or formed pointing in opposite directions. This configuration is advantageous, in particular, if the cooling device comprises two or more heat exchangers. A particularly compact arrangement of the two or more heat exchangers can thus be achieved.

For a connection of an inlet and an outlet of two heat exchangers to one another, it is favorable if the inlet and/or the outlet are configured in the form of a connection piece. Inlets and outlets of that kind can also be connected to the CO₂ connection line in a simple and reliable manner.

It is also favorable if the outlet of one of the two or more heat exchangers is connected to the inlet of the heat exchanger arranged downstream in the flow direction of the CO₂ in the CO₂ connection line. Such a connection can be established, in particular, by way of a pipe section that extends transversely, in particular perpendicularly, to the cooling channel longitudinal axis of the cooling channel. This configuration enables, in particular, a compact structure of the cooling device.

It is further favorable if the cleaning appliance comprises a CO₂ connection that is connected or connectable to a CO₂ source, and if the CO₂ connection is fluidically connected to the CO₂ connection line. This configuration makes it possible, in particular, to feed liquid or pressurized CO₂ to the cleaning appliance by way of the CO₂ connection. Such a cleaning appliance can be connected, for example, to a CO₂ bottle that contains liquid CO₂. Said liquid CO₂ can then be fed to the expansion device by way of the CO₂ connection line.

It is advantageous if the expansion device comprises a switching device for opening and closing a fluidic connection between the CO₂ connection and the expansion chamber inlet and if the switching device is arranged or formed between the cooling device and the expansion chamber inlet. Such a configuration makes it possible, in particular, to operate the expansion device in a pulsed manner, such that liquid or pressurized gaseous CO₂ is only able to flow through the CO₂ connection line when the fluidic connection between the CO₂ connection and the expansion chamber inlet is open. The formation of CO₂ snow can thus be controlled in a simple manner with the switching device.

The present invention further relates to a method for cooling liquid or pressurized CO₂ when supplying to an expansion device, said expansion device being configured to produce CO₂ snow by expanding the liquid or pressurized CO₂, of a cleaning appliance for blasting surfaces to be treated with a mixed stream of a pressurized gas and CO₂ pellets, in particular of a cleaning appliance as described in the outset, wherein the cleaning appliance comprises an apparatus for producing CO₂ pellets from the liquid or pressurized CO₂, wherein the apparatus comprises a compaction device for compacting CO₂ snow to form the CO₂ pellets, wherein the compaction device comprises the expansion device, wherein the liquid or pressurized CO₂ is cooled passively, in particular in counterflow, with gaseous CO₂ exhaust gas that arises during the production of the CO₂ snow and the CO₂ pellets, wherein for cooling the liquid or pressurized CO₂, the CO₂ exhaust gas is conducted through a cooling channel, which is surrounded at least in sections, in particularly completely, by a CO₂ channel in the circumferential direction relative to a direction of extent defined thereby, which CO₂ channel is in thermal contact with the cooling channel and through which the liquid or pressurized CO₂ is guided.

As already explained in detail, such a method developed further enables an improved efficiency of the cleaning appliance. A cooling capacity for pre-cooling the liquid or pressurized CO₂ can thus be significantly increased compared to known cleaning appliances. In particular, the method can be performed with one of the cleaning appliances described above.

It is favorable if the liquid or pressurized CO₂ is expanded before cooling, in particular before or during introduction into the CO₂ channel in thermal contact with the cooling channel, without CO₂ snow forming. Due to the expansion, for example by increasing a flow cross-section, a dwell time in the CO₂ channel is able to be increased and thus a better heat transfer between the CO₂ exhaust gas and the liquid or pressurized CO₂ is able to be achieved without CO₂ snow forming, which would clog the CO₂ channel.

Furthermore, the use of one of the cleaning appliances described above is proposed for performing one of the methods described above.

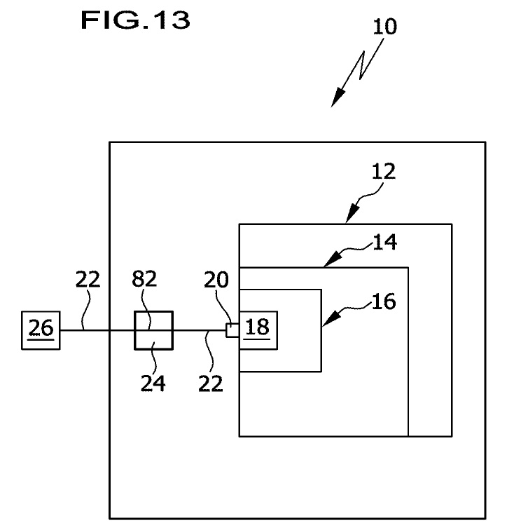

Schematically depicted in FIG. 13 is an embodiment of a cleaning appliance, denoted as a whole with the reference numeral 10, for blasting surfaces to be treated with a mixed stream of a pressurized gas, for example water-free or substantially water-free, i.e. dry pressurized air, and CO₂ pellets. The cleaning appliance 10 comprises an apparatus 12 for producing CO₂ pellets from liquid or pressurized gaseous CO₂.

The apparatus 12 comprises a compaction device 14 for compacting CO₂ snow to form the CO₂ pellets.

The compaction device 14 comprises an expansion device 16 for creating CO₂ snow by expanding liquid or pressurized CO₂. The expansion device 16 comprises an expansion chamber 18 with an expansion chamber inlet 20. Furthermore, the cleaning appliance 10 comprises a CO₂ connection line 22 that is fluidically connected to the expansion chamber inlet 20 for supplying the liquid or pressurized CO₂ to the expansion device 16.

For pre-cooling the liquid or pressurized CO₂, the cleaning appliance 10 comprises a cooling device 24 for cooling liquid or pressurized CO₂ flowing through the CO₂ connection line 22. The CO₂ connection line 22 is connectable or connected to a CO₂ source 26. The CO₂ source may be, in particular, a CO₂ bottle 28 with liquid CO₂ or a CO₂ pressurized gas source.

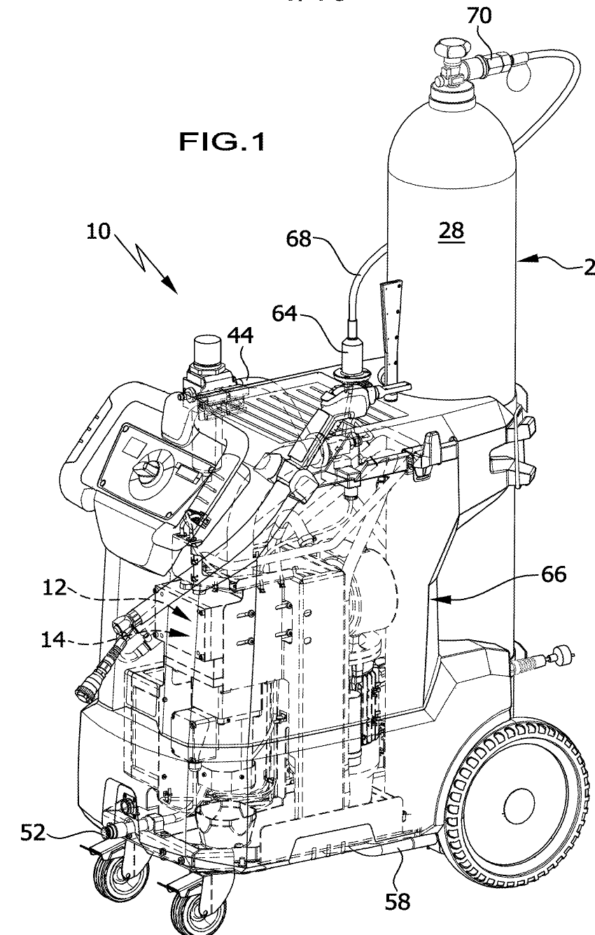

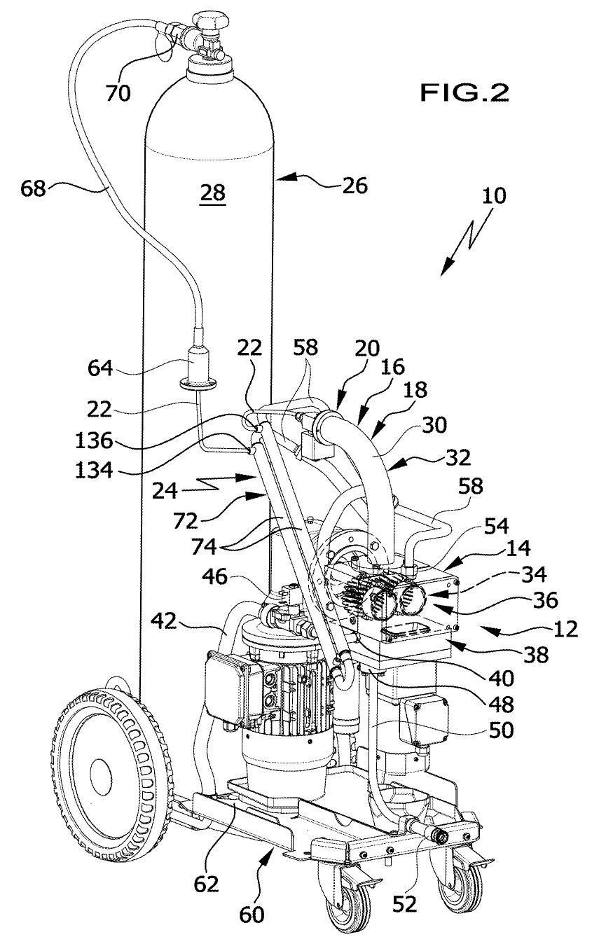

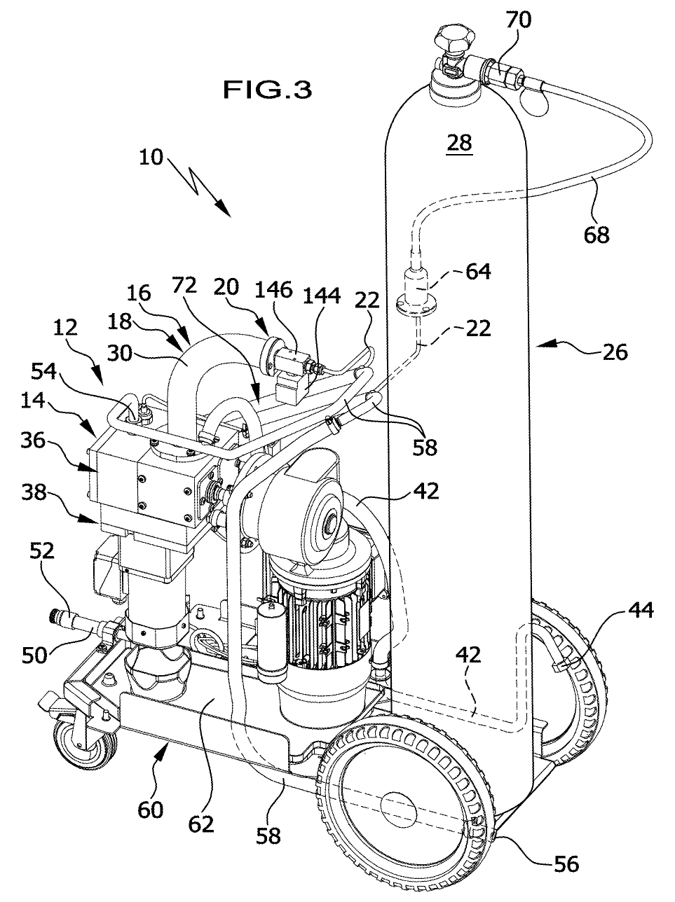

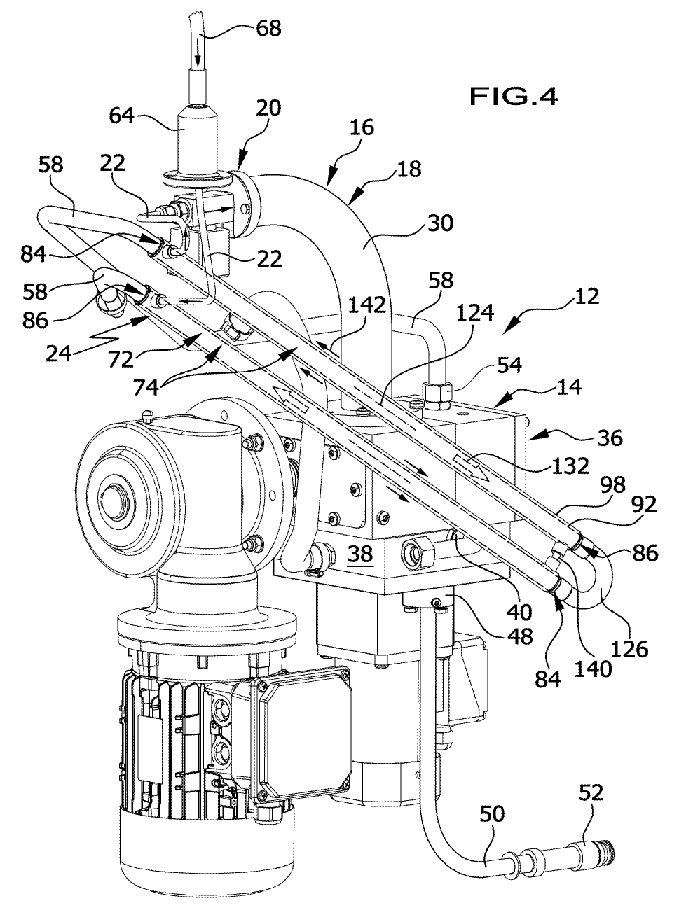

In the case of the embodiment of the cleaning appliance 10 depicted in FIG. 13, the cooling device 24 is configured in the form of a passive cooling device 24, which is described in more detail below in connection with the embodiment depicted in FIGS. 1 to 6.

FIGS. 1 to 6 show a further embodiment of a cleaning appliance 10 for blasting surfaces to be treated with a mixed stream of a pressurized gas and CO₂ pellets. This embodiment of the cleaning appliance 10 also comprises an apparatus 12 for producing CO₂ pellets from liquid or pressurized gaseous CO₂.

The apparatus 12 comprises a compaction device 14 for compacting CO₂ snow to form the CO₂ pellets.

The compaction device 14 comprises an expansion device 16 for creating CO₂ snow by expanding liquid or pressurized CO₂. The expansion device 16 comprises an expansion chamber 18 in the form of a pipe 30 bent by 90°.

The expansion chamber 18 comprises an expansion chamber inlet 20, on which an expansion nozzle not depicted in the Figures is arranged, by means of which liquid or pressurized gaseous CO₂ is able to be conducted into the expansion chamber 18. The expansion chamber 18 forms a portion of a pre-compacting device 32 in which CO₂ snow is pre-compacted and then supplied to the main compacting device 36 configured in the form of a gear compactor 34.

A pellet delivery device 38 is arranged downstream of the main compacting device 36.

The pellet delivery device 38 comprises a pressurized gas inlet 40, which is fluidically connected to a pressurized gas connection 44 by way of a connection line 42. Arranged on the connection line 42 is a valve 46 in order to selectively open or close the connection line 42 to enable or interrupt a pressurized gas stream.

The pellet delivery device 38 further comprises a mixed stream outlet 48, which is fluidically connected to a mixed stream connection 52 by way of a connection line 50. The mixed stream connection 52 can be connected by way of a hose to a blasting nozzle, which can be guided by a user for cleaning or blasting the surfaces to be treated with the mixed stream. For the sake of clarity, both the hose and the blasting nozzle are not depicted in the Figures.

The compaction device 14 comprises a CO₂ exhaust gas outlet 54 out of which gaseous CO₂, also referred to as CO₂ exhaust gas, exits the compaction device 14, said gaseous CO₂ being created through sublimation during the production of CO₂ pellets.

The cleaning appliance 10 further comprises a CO₂ cleaning appliance exhaust gas outlet 56, which is fluidically connected to the CO₂ exhaust gas outlet 54, namely by way of a CO₂ exhaust gas line 58.

The cleaning appliance 10 further comprises a movable frame 60 on which all components of the cleaning appliance 10 are arranged. The cleaning appliance 10 can thus be moved by a user in a simple and comfortable manner.

Formed on the frame 60 is a platform 62 on which a CO₂ bottle 28 is positionable as schematically depicted in FIGS. 1 to 3. The CO₂ bottle 28 forms a CO₂ source 26.

The cleaning appliance 10 comprises a CO₂ connection 64, which is conducted out of a housing 66 of the cleaning appliance 10. The CO₂ connection 64 can be connected to a connection 70 of the CO₂ bottle 28 by way of a connecting line 68. The CO₂ connection 64 is fluidically connected to the CO₂ connection line 22 in this way.

In the embodiment of FIGS. 1 to 6, the cooling device 24 is configured in the form of a passive cooling device. It is configured in the form of a counterflow cooling device 72.

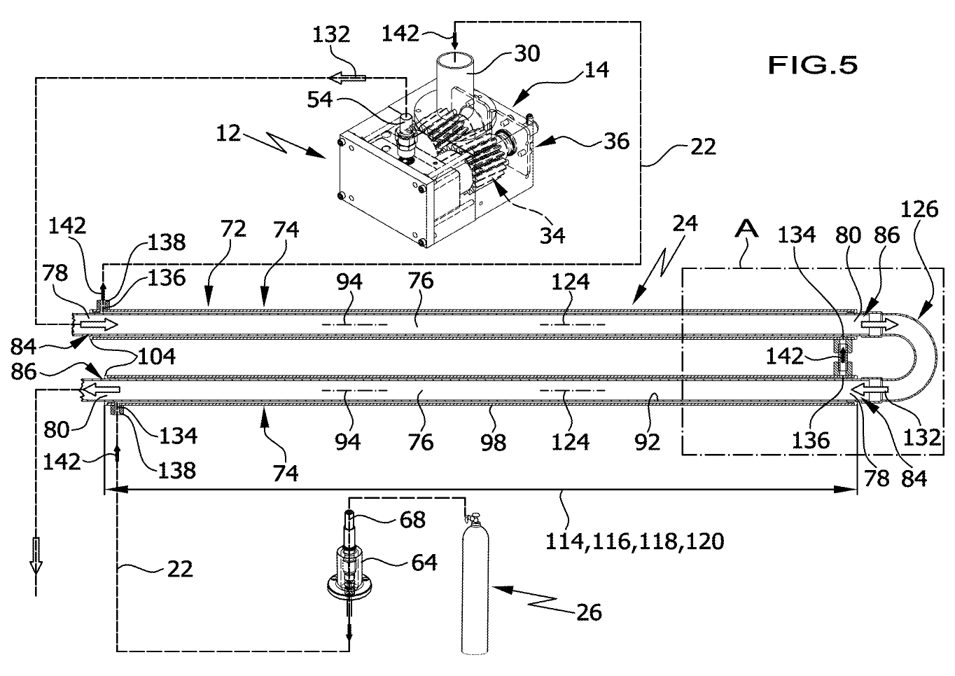

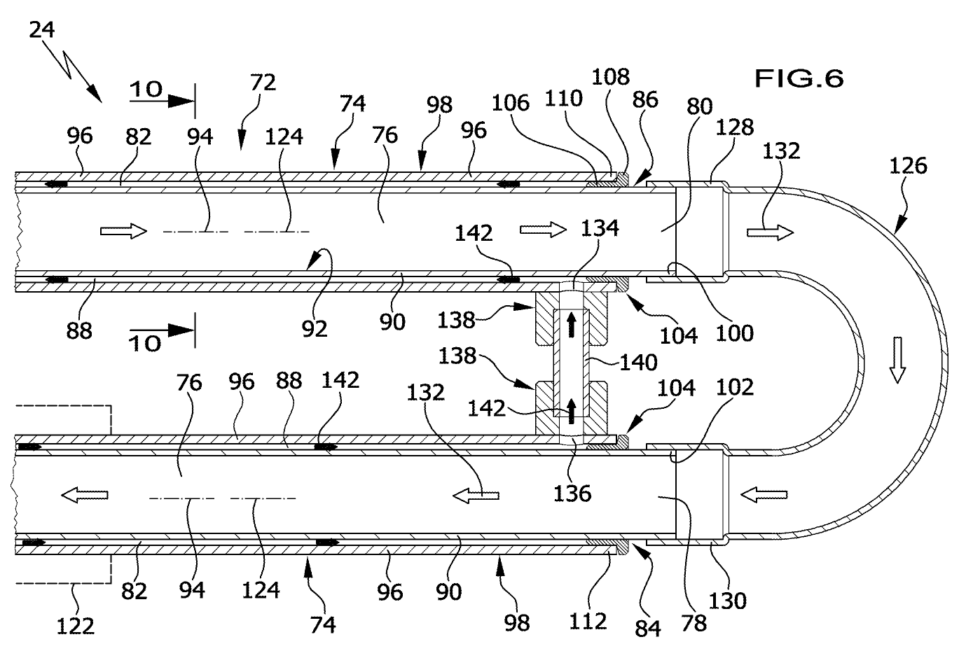

The cooling device 24 comprises two heat exchangers 74 within the meaning of the claims. The structure of the heat exchangers 74 is described in more detail in the following in connection with FIGS. 5 and 6.

Each heat exchanger 74 defines or comprises a cooling channel 76 with a cooling channel inlet 78 and a cooling channel outlet 80. The CO₂ connection line 22, namely a connection line portion of the CO₂ connection line 22 forming a CO₂ channel, is also comprised by the heat exchanger 74. In the heat exchanger 74, the cooling channel 76 extends through the CO₂ channel 82.

The heat exchanger 74 defines an inlet side 84 and an outlet side 86, namely such that the cooling channel inlet 78 is arranged or formed on the inlet side 84 and that the cooling channel outlet 80 is arranged or formed on the outlet side 86.

The CO₂ channel 82 extends between the outlet side 86 and the inlet side 84 in the form of an annular space 88 around the cooling channel 76.

The cooling channel 76 is separated from the CO₂ channel 82 by a heat exchange wall 90. The heat exchange wall 90 is thermally conductive and thus establishes a thermal contact or a thermal connection between the cooling channel 76 and the CO₂ channel 82.

The heat exchange wall 90 is formed by a cooling channel pipe 92.

The cooling channel pipe 92 is made of a metallic material with a high thermal conductivity. The cooling channel pipe 92 is of elongate rectilinear configuration, such that the cooling channel 76 also extends rectilinearly and defines a cooling channel longitudinal axis 94.

As described, the annular space 88 is delimited on one side by the heat exchange wall 90. Further, it is delimited on another side by a CO₂ channel wall 96. The CO₂ channel 82 thus extends between the heat exchange wall 90 and the CO₂ channel wall 96 to form the annular space 88.

The CO₂ channel wall 96 is formed by a CO₂ channel pipe 98. A longitudinal axis of the CO₂ channel pipe 98 coincides with the cooling channel longitudinal axis 94, because in the case of the described embodiment, the CO₂ channel pipe 98 surrounds the cooling channel pipe 92 concentrically.

The CO₂ channel pipe 98 is made of a metallic or thermally insulating, non-metallic material. Like the cooling channel pipe 92, it is dimensioned such that it is able to withstand the liquid or pressurized CO₂ flowing in the CO₂ channel 82 and a bursting thereof is avoided.

Due to the arrangement of the cooling channel pipe 92 in the interior of the CO₂ channel pipe 98, the CO₂ channel 82 also extends rectilinearly, namely concentrically to the cooling channel 76. In the case of the heat exchanger 74, the cooling channel inlet 78 and the cooling channel outlet 80 are formed concentrically relative to the cooling channel longitudinal axis 94.

The cooling channel inlet 78 and the cooling channel outlet 80 are formed by free pipe ends 100 and 102, respectively. These serve simultaneously as connection pieces, for example for a CO₂ exhaust gas hose or the CO₂ exhaust gas line 58.

The CO₂ channel 82 extends, as described, from the outlet side 86 around the cooling channel 76 to the inlet side 84 of the heat exchanger 74.

The annular space 88 is closed on both sides in each case by way of a sealing element 104. It projects with a short hollow-cylindrical portion 106 into the annular space 88 between the CO₂ channel pipe 98 and the cooling channel pipe 92. Further, formed on the portion 106 of the sealing element 104 is a flange 108 pointing in a radial direction away from the cooling channel longitudinal axis, said flange 108 abutting against a free end 110 or 112 of the CO₂ channel pipe 98.

The compaction device 14 comprises a CO₂ exhaust gas outlet 54, which is fluidically connected to the cooling channel inlet 78 of one of the two heat exchangers 74. The CO₂ exhaust gas line 58 serves the purpose of fluidic connection.

A cross-sectional area of the CO₂ exhaust gas line 58 that fluidically connects the CO₂ exhaust gas outlet 54 and the cooling channel inlet 78 to one another corresponds to a cooling channel cross-sectional area of the cooling channel 76. The CO₂ exhaust gas can thus flow substantially unimpeded from the CO₂ exhaust gas outlet 54 through the CO₂ exhaust gas line 58 and the cooling channel 76.

The CO₂ cleaning appliance exhaust gas outlet 56 is fluidically connected to the cooling channel outlet 80 by way of the CO₂ exhaust gas line 58. The cross-sectional area of the CO₂ exhaust gas line 58 that fluidically connects the CO₂ cleaning appliance exhaust gas outlet 56 and the cooling channel outlet 80 of the one heat exchanger 74 to one another corresponds to a cooling channel cross-sectional area of the cooling channel 76. The CO₂ exhaust gas is thus able to flow unimpeded from the CO₂ exhaust gas outlet 74 to the cleaning appliance exhaust gas outlet 56 and be discharged to the environment of the cleaning appliance 10.

The heat exchanger 74 has a heat exchanger length 114. Said heat exchanger length 114 is defined by a cooling channel length 116 of the cooling channel 76 and also corresponds to a CO₂ channel length 118 of the CO₂ channel 82. The heat exchanger length 114 corresponds to a distance 120 between the inlet side 84 and the outlet side 86 of the heat exchanger 74.

A ratio between the CO₂ channel length 118 and the heat exchanger length 114 is thus 1:1 in the case of the described embodiment.

The heat exchanger length 114 of the heat exchanger 74 in the case of the embodiment depicted in FIGS. 1 to 6 is in a range of about 0.5 m to about 2 m. Further, it is in a range of about 0.8 m to about 1.3 m. It is about 1 m.

Optionally, as shown only partially in FIG. 6 with dashed lines, the heat exchanger 74 may comprise a thermal insulation 122 surrounding the CO₂ channel 82 on an outer side facing away from the cooling channel 76, in order to minimize an undesired heating of the liquid or pressurized CO₂ flowing through the CO₂ channel 82. The insulation 122 is thus arranged or formed on an outer side of the CO₂ channel wall 96 facing away from the CO₂ channel 82.

In the case of the cleaning appliance 10 schematically depicted in FIGS. 1 to 6, the cooling channel 76 and the CO₂ channel 82 are configured free of heat conducting elements. This means, in particular, that the cooling channel 76 and the CO₂ channel 82 are delimited by macroscopically smooth wall surfaces that are formed by the cooling channel pipe 82 and the CO₂ channel pipe 98.

As already noted, the cooling device 24 of the cleaning appliance 10 according to the embodiment of FIGS. 1 to 6 comprises two heat exchangers 74. The two heat exchangers 74 are arranged in such a way that their heat exchanger longitudinal axes 124 extend in parallel or substantially in parallel with one another.

In the case of the embodiment of FIGS. 1 to 6, the two heat exchangers 74 are arranged in series one after the other, namely in such a way that the cooling channels 76 of the two heat exchangers 74 are flowed through one after the other, i.e. in series, by the CO₂ exhaust gas stream that is conducted through the CO₂ exhaust gas line 58 from the CO₂ exhaust gas outlet 54 to the cooling channel inlet 78 of the one of the two heat exchangers 74.

As schematically depicted in FIG. 6, the two heat exchangers 74 are connected to one another in such a way that the cooling channel outlet 80 of the heat exchanger 74 flowed through first is fluidically connected to the cooling channel inlet 78 of the heat exchanger 74 arranged downstream in the flow direction of the CO₂ exhaust gas. This is achieved by a semicircular pipe section 126 that has a sleeve 128 and 130 on each of the two ends, said sleeves being slid over the cooling channel outlet 80 on the one hand and over the cooling channel inlet 78 on the other hand and being connected thereto in a fluid-tight manner.

As schematically depicted in FIG. 6, a CO₂ exhaust gas stream symbolized by the unfilled arrows 132 flows through the cooling channel 76 of the first heat exchanger 74 and is then redirected by 180° by the pipe section 126, such that it is able to be conducted through the parallel cooling channel 76 of the second heat exchanger 74.

The CO₂ channel 82 of the heat exchanger 74 comprises an inlet 134 and an outlet 136. The inlet 134 and the outlet 136 are open pointing transversely, namely perpendicularly, in the radial direction relative to the heat exchanger longitudinal axis 124. The inlet 134 and the outlet 136 on the heat exchanger 74 are oriented in parallel, but are arranged or formed pointing in opposite directions. For connecting the inlet 134 and the outlet 136 to the CO₂ connection line 22, the inlet 134 and the outlet 136 are configured in the form of connection pieces 138.

As already explained, the two cooling channels 76 of the two heat exchangers 74 are connected to one another by way of the pipe section 126. Likewise, a connection between the outlet 136 of the one heat exchanger 74 to the inlet 134 of the heat exchanger 74 arranged downstream in the flow direction of the CO₂ in the CO₂ connection line 22 is established fluidically by way of a pipe section 140. Said pipe section 140 extends transversely, namely perpendicularly, to the cooling channel longitudinal axis 94 of the cooling channel 76, thus also perpendicularly to the heat exchanger longitudinal axis 124.

The liquid or pressurized CO₂ flows through the CO₂ connection line 22 and the CO₂ channel 82 in a flow direction that is symbolized schematically by the filled arrows 142. The CO₂ exhaust gas, symbolized by the arrows 132, and the liquid or pressurized CO₂, symbolized by the filled arrows 142, thus flow through the heat exchanger 74 in opposite flow directions. The liquid or pressurized CO₂ is thus pre-cooled by the CO₂ exhaust gas in counterflow.

In order to be able to control the inflow of liquid or pressurized CO₂ through the expansion chamber inlet 20, the expansion device 16 comprises a switching device 144 for opening and closing a fluid connection between the CO₂ connection 64 and the expansion chamber inlet 20. The switching device 144 comprises an electromagnetic valve 146, which is arranged in the CO₂ connection line 22 in order to selectively open and close it. In the embodiment depicted in FIGS. 1 to 6, the switching device 144 is arranged or formed between the cooling device 24 and the expansion chamber inlet 20.

Further, in the cleaning appliance 10, the dimensions of the CO₂ connection line 22 and the CO₂ channel 82 are coordinated in a particular manner. Outside the heat exchanger 74, the CO₂ connection line 22 defines a first cross-sectional area. The CO₂ channel 82 defines a second cross-sectional area. The second cross-sectional area is greater than the first cross-sectional area, thus the first cross-sectional area is smaller than the second cross-sectional area.

A ratio of the first cross-sectional area and the second cross-sectional area is in a range of about 1:8 to about 1:2 in the case of the embodiment depicted in FIGS. 1 to 6. Further, the ratio is in a range of about 1:6 to about 1:3. In the embodiment, the ratio is about 1:4.

Providing the first cross-sectional area smaller than the second cross-sectional area has the effect, in particular, that the CO₂ flowing through the inlet 134 from the CO₂ connection line 22 is able to expand due to the cross-sectional widening and flow slightly more slowly through the CO₂ channel 82 than through the CO₂ connection line 22. The dwell time of the CO₂ in the CO₂ channel 82 is thus increased, such that the flowing CO₂ is able to absorb more heat from the CO₂ exhaust gas than is the case with a heat exchanger in which the ratio of the first and second cross-sectional areas is about 1:1. An efficiency of the heat exchanger 74 can be significantly increased in this way.

The cross-sectional widening at the transition from the CO₂ connection line 22 to the CO₂ channel 82 compensates, in particular, the lack of heat conducting elements. In addition, the structure of the heat exchanger according to the embodiment of FIGS. 1 to 6 is significantly more simple than, for example, in the case of the heat exchanger that is described in DE 10 2022 109 526 A1.

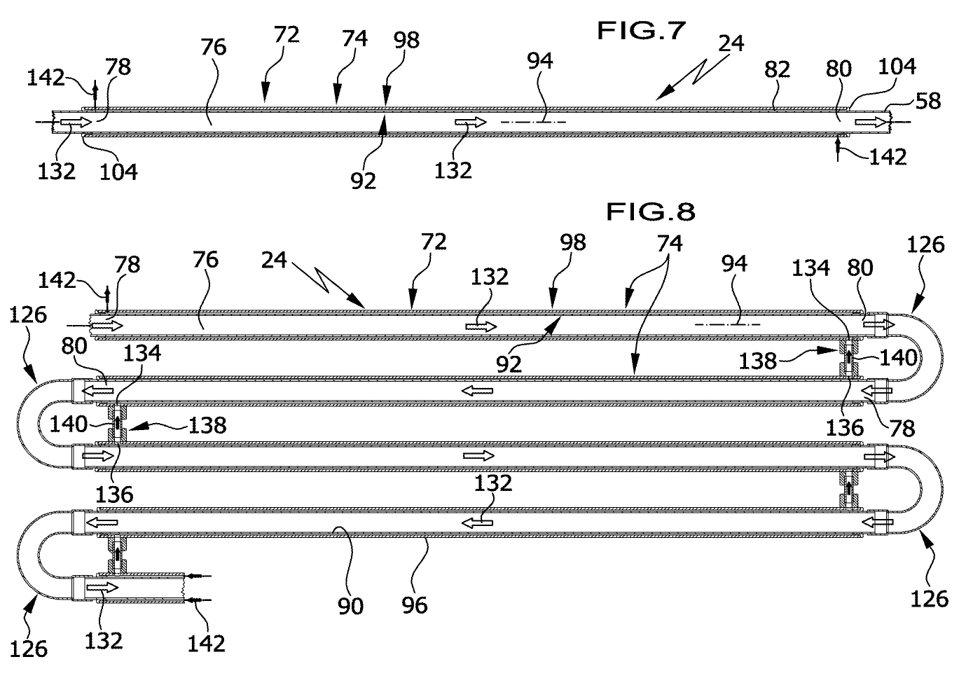

FIG. 7 shows schematically a depiction of an individual heat exchanger 74. Instead of the cooling device 24, which, as explained above in connection with FIGS. 5 and 6, comprises two heat exchangers 74, the cleaning appliance 10 may optionally also be equipped with a cooling device 24 that comprises only one single heat exchanger 74, as is schematically depicted in FIG. 7. In the case of the heat exchanger 74 according to the embodiment of FIG. 7, too, an inlet 134 and an outlet 136, which are not depicted in the Figure, are provided on the CO₂ channel 82. For example, they are configured as above in the case of the embodiment of FIGS. 5 and 6.

FIG. 8 schematically shows a further embodiment of a cooling device 24 that comprises five heat exchangers 74. They are configured in the form of a cascade, i.e., arranged downstream of one another, such that the CO₂ exhaust gas flows through all cooling channels 76 one after the other as well as the pipe sections 126 connecting the cooling channels 76. The liquid CO₂ is conducted through the CO₂ channels 82 one after the other in the manner described above in connection with FIGS. 5 and 6, said CO₂ channels 82 being fluidically connected to one another from heat exchanger 74 to downstream heat exchanger 74 by way of the pipe sections 140.

The embodiments of FIGS. 5 to 8 serve merely to illustrate that the structure of the heat exchanger 74 makes it possible to individually configure cooling devices 24 having different cooling capacities, wherein to increase the cooling capacity compared to one single heat exchanger 74, in particular any number of heat exchangers 74 may be provided.

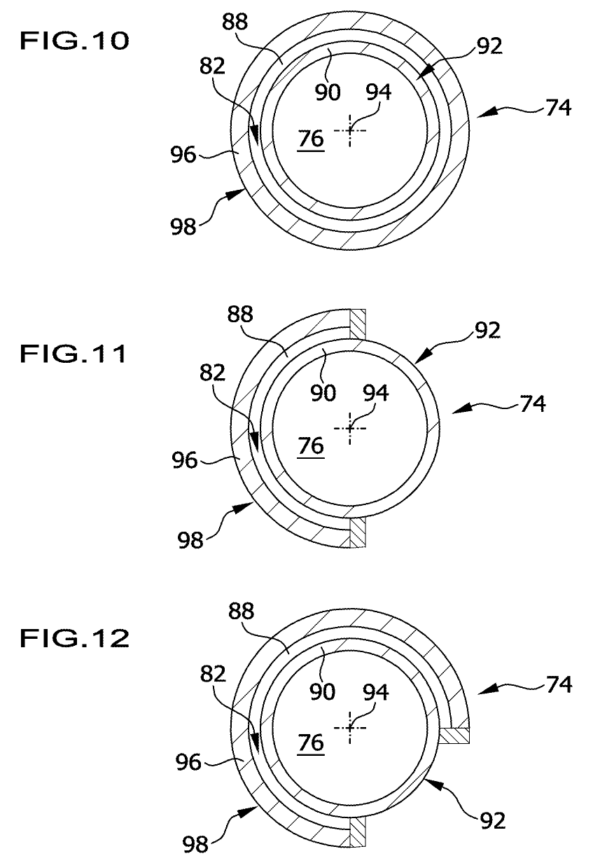

FIG. 10 schematically shows a cross section view along line 10-10 of FIG. 6. As explained, the CO₂ channel pipe 98 and the cooling channel pipe 92 are arranged concentrically to the cooling channel longitudinal axis 94. The annular space 88 that forms the CO₂ channel 82 is easily visible here.

FIG. 11 schematically shows a section view similar to FIG. 10, but of a further embodiment in which the CO₂ channel 82 surrounds the cooling channel 76 in the circumferential direction relative to the cooling channel longitudinal axis 94, thus relative to the direction of extent of the cooling channel 76, not completely, but rather only in sections, namely over a circumference of about 180°. Thus, unlike in FIG. 10, only one CO₂ pipe 98 halved lengthwise is provided, thus a hollow-cylindrical half-shell, to delimit the CO₂ channel 82 on the outside, i.e., opposite the heat exchange wall. The annular space 88 thus extends only over a circumferential angle relative to the cooling channel longitudinal axis 94 of about 180°.

A further embodiment in which the CO₂ channel 82 surrounds the cooling channel 76 in the circumferential direction relative to the cooling channel longitudinal axis 94 only in sections or partially is schematically depicted in FIG. 12. Here, the CO₂ channel 82 surrounds the cooling channel 76 over a circumferential angle of about 270°.

An efficiency of the embodiments of heat exchangers 74 according to FIGS. 11 and 12 is reduced compared to the embodiment of FIG. 10 due to the reduced thermal contact via the heat exchange wall 90. The heat exchangers 74 according to FIGS. 11 and 12 can also be combined with one another basically in any number to form a cooling device 24. It is also conceivable to combine heat exchangers 74 in which the cooling channel 76 is surrounded by the CO₂ channel 82 over different circumferential angles, for example the heat exchanger 74 according to FIG. 11 with a heat exchanger 74 according to FIG. 12 or a heat exchanger 74 according to FIG. 11 with a heat exchanger 74 according to FIG. 10.

To improve an effect of the heat exchanger 74, it may further comprise a turbulence device 146 for generating a turbulent flow of the CO₂ exhaust gas stream flowing in the cooling channel 76, said stream being symbolized by the arrows 132.

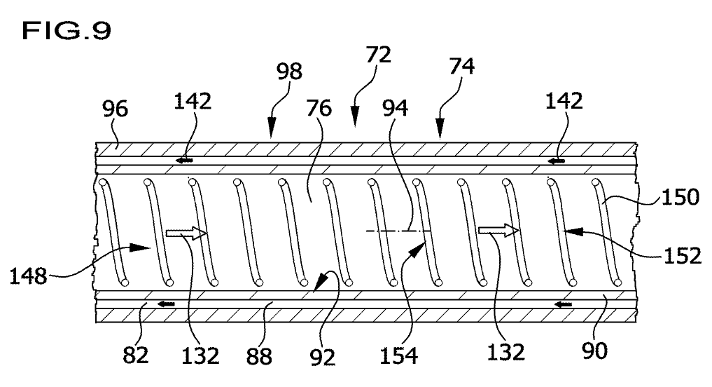

In the embodiment of FIG. 9, the turbulence device 146 comprises a turbulence element 148, which is arranged or formed in the cooling channel 76. The turbulence element 148 is configured in the form of a helical projection 150, which projects from an inner wall of the cooling channel pipe 92. The projection 150 winds helically along the inner wall.

In the embodiment of FIG. 9, the turbulence element 148 is configured in the form of a coil spring 152. Said coil spring 152 is dimensioned such that it is able to be inserted into the cooling channel 76 and is held clampingly against the inner wall of the cooling channel pipe 92 as a result of its spring action.

As described, the turbulence device 146 is connected to the cooling channel pipe 92 in a force-locking manner. Optionally, a positive-locking and/or material bonded connection between the turbulence device 146 and the cooling channel pipe 92 may also be provided in other embodiments.

By means of the cooling device 24, an efficiency in the production of CO₂ pellets with the compaction device 14 can be significantly increased, namely by over 25% compared to a cleaning appliance 10 that has no heat exchanger 74. In other words, this means that with the same contents of the CO₂ bottle 28, 25% more CO₂ pellets can be produced with the cleaning appliance 10 according to the embodiment of FIGS. 1 to 6, and thus a treatment duration increased by 25% for surfaces to be treated is achievable with equal CO₂ pellet quality and production rate. The CO₂ bottle 28 thus has to be replaced less frequently. Furthermore, costs in the operation of the cleaning appliance 10 can thus be significantly reduced and the environmental impact can be minimized.

### REFERENCE NUMERAL LIST

10 cleaning appliance

12 apparatus

14 compaction device

16 expansion device

18 expansion chamber

20 expansion chamber inlet

22 CO₂ connection line

24 cooling device

26 CO₂ source

28 CO₂ bottle

30 pipe

32 pre-compacting device

34 gear compactor

36 main compaction device

38 pellet delivery device

40 pressurized gas inlet

42 connection line

44 pressurized gas connection

46 valve

48 mixed stream outlet

50 connection line

52 mixed stream connection

54 CO₂ exhaust gas outlet

56 CO₂ cleaning appliance exhaust gas outlet

58 CO₂ exhaust gas line

60 frame

62 platform

64 CO₂ connection

66 housing

68 connecting line

70 connection

72 counterflow cooling device

74 heat exchanger

76 cooling channel

78 cooling channel inlet

80 cooling channel outlet

82 CO₂ channel

84 inlet side

86 outlet side

88 annular space

90 heat exchange wall

92 cooling channel pipe

94 cooling channel longitudinal axis

96 CO₂ channel

98 CO₂ channel pipe

100 free pipe end

102 free pipe end

104 sealing element

106 portion

108 flange

110 free end

112 free end

114 heat exchanger length

116 cooling channel length

118 CO₂ channel length

120 distance

122 insulation

124 heat exchanger longitudinal axis

126 pipe section

128 sleeve

130 sleeve

132 arrow

134 inlet

136 outlet

138 connecting piece

140 pipe section

142 arrow

144 switching device

146 valve

148 turbulence device

150 turbulence element

152 projection

154 coil spring

1. A cleaning appliance for blasting surfaces to be treated with a mixed stream of a pressurized gas and CO₂ pellets, comprising an apparatus for producing CO₂ pellets from liquid or pressurized CO₂ wherein the apparatus comprises a compaction device for compacting CO₂ snow to form the CO₂ pellets, wherein the compaction device comprises an expansion device for producing CO₂ snow by expanding liquid or pressurized CO₂ wherein the expansion device comprises an expansion chamber having an expansion chamber inlet, and wherein the cleaning appliance comprises a CO₂ connection line fluidically connected to the expansion chamber inlet for supplying the liquid or pressurized CO₂ to the expansion device, wherein the cleaning appliance comprises a passive cooling device, in particular in the form of a counterflow cooling device, for cooling liquid or pressurized CO₂ flowing through the CO₂ connection line, wherein the cooling device comprises at least one heat exchanger, which comprises a cooling channel defining a direction of extent and comprises a CO₂ channel, wherein the CO₂ channel forms a connection line portion of the CO₂ connection line, wherein the cooling channel is surrounded at least in sections, in particular completely, by the CO₂ channel in the circumferential direction relative to the direction of extent.

2. The cleaning appliance in accordance with claim 1, wherein the cooling channel extends in the direction of extent through the CO₂ channel.

3. The cleaning appliance in accordance with claim 1, wherein the CO₂ channel forms an annular space surrounding the cooling channel.

4. The cleaning appliance in accordance with claim 1, wherein the cooling channel is delimited from the CO₂ channel by a heat exchange wall and is in thermal contact with said CO₂ channel.

5. The cleaning appliance in accordance with claim 4, wherein the heat exchange wall is formed by a cooling channel pipe,
wherein in particular the cooling channel pipe defining the cooling channel is made of a metallic material.

6. The cleaning appliance in accordance with claim 4, wherein the CO₂ channel extends between the heat exchange wall and a CO₂ channel wall.

7. The cleaning appliance in accordance with claim 6, wherein the CO₂ channel wall is formed by a CO₂ channel pipe,
wherein in particular the CO₂ channel pipe delimiting the CO₂ channel on the outside is made of a metallic or thermally insulating, non-metallic material.

8. The cleaning appliance in accordance with claim 1, wherein at least one of
a) the cooling channel extends rectilinearly and defines a cooling channel longitudinal axis and
b) the CO₂ channel extends rectilinearly, in particular concentrically to the cooling channel.

9. The cleaning appliance in accordance with claim 1, wherein the at least one heat exchanger, in particular the cooling channel, has a heat exchanger length in a range of about 0.5 m to about 2 m, in particular a heat exchanger length in a range of about 0.8 m to about 1.3 m, further in particular about 1 m.

10. The cleaning appliance in accordance with claim 1, wherein the CO₂ connection line defines a first cross-sectional area outside of the heat exchanger, wherein the CO₂ channel defines a second cross-sectional area, and wherein the first cross-sectional area is smaller than the second cross-sectional area,
wherein in particular a ratio of the first cross-sectional area and the second cross-sectional area is in a range of about 1:8 to about 1:2, in particular in a range of about 1:6 to about 1:3, further in particular is about 1:4.

11. The cleaning appliance in accordance with claim 1, wherein the at least one heat exchanger has an inlet side and an outlet side, wherein the cooling channel comprises a cooling channel inlet and a cooling channel outlet, and wherein the cooling channel inlet is arranged or formed on the inlet side, and wherein the cooling channel outlet is arranged or formed on the outlet side,
wherein, in particular, at least one of
a) the cooling channel inlet and the cooling channel outlet are arranged or formed concentrically relative to the cooling channel longitudinal axis and
b) the CO₂ channel extends from the outlet side around the cooling channel to the inlet side.

12. The cleaning appliance in accordance with claim 11, wherein the compaction device comprises a CO₂ exhaust gas outlet and wherein the CO₂ exhaust gas outlet is fluidically connected to the cooling channel inlet,
wherein in particular a cross-sectional area of a first CO₂ exhaust gas line that fluidically connects the CO₂ exhaust gas outlet and the cooling channel inlet to one another corresponds to or substantially corresponds to a cooling channel cross-sectional area of the cooling channel.

13. The cleaning appliance in accordance with claim 11, wherein the cleaning appliance comprises a CO₂ cleaning appliance exhaust gas outlet and wherein the cooling channel outlet is fluidically connected to the CO₂ cleaning appliance exhaust gas outlet,
wherein in particular a cross-sectional area of a second CO₂ exhaust gas line that fluidically connects the CO₂ cleaning appliance exhaust gas outlet and the cooling channel outlet to one another corresponds to or substantially corresponds to a cooling channel cross-sectional area of the cooling channel.

14. The cleaning appliance in accordance with claim 11, wherein the CO₂ channel has a CO₂ channel length, wherein the at least one heat exchanger has a heat exchanger length, which corresponds to a distance between the inlet side and the outlet side, and wherein a ratio between the CO₂ channel length and the heat exchanger length is about 1:1.

15. The cleaning appliance in accordance with claim 1, wherein the at least one heat exchanger comprises a thermal insulation surrounding the CO₂ channel on an outer side facing away from the cooling channel,
wherein in particular the thermal insulation is arranged or formed on an outer side of the CO₂ channel wall facing away from the CO₂ channel.

16. The cleaning appliance in accordance with claim 1, wherein at least one of the cooling channel and the CO₂ channel at least one of
a) are configured free of heat conducting elements and
b) are delimited by macroscopically smooth wall surfaces.

17. The cleaning appliance in accordance with claim 1, wherein the at least one heat exchanger comprises a turbulence device for generating a turbulent flow in a CO₂ gas stream flowing through the cooling channel.

18. The cleaning appliance in accordance with claim 17, wherein the turbulence device at least one of
a) comprises at least one turbulence element, which is arranged or formed in the cooling channel, wherein in particular the at least one turbulence element is configured in the form of a helical projection, in particular in the form of a coil spring, and
b) is connected to the cooling channel pipe in a force-locking and/or positive-locking and/or materially bonded manner.

19. The cleaning appliance in accordance with claim 1, wherein the cooling device comprises two or more heat exchangers,
wherein, in particular, at least one of
a) heat exchanger longitudinal axes of the two or more heat exchangers extend in parallel or substantially in parallel with one another and
b) the two or more heat exchangers are arranged in series one after the other in such a way that the cooling channels of the two or more heat exchangers are flowed through one after the other by a CO₂ exhaust gas stream, and
c) the cooling channel outlet of one of the two or more heat exchangers is fluidically connected to the cooling channel inlet of the heat exchanger arranged downstream in the flow direction of the CO₂ exhaust gas, in particular by way of a pipe section of semicircular or substantially semicircular configuration.

20. The cleaning appliance in accordance with claim 1, wherein the CO₂ channel of the at least one heat exchanger comprises an inlet and an outlet, which are open pointing transversely, in particular perpendicularly, in the radial direction relative to a heat exchanger longitudinal axis of the at least one heat exchanger,
wherein in particular at least one of
a) the inlet and the outlet are oriented in parallel or substantially in parallel with one another and
b) the inlet and the outlet are arranged or formed pointing in opposite directions and
c) the inlet and/or the outlet are configured in the form of a connection piece and
d) the outlet of one of the two or more heat exchangers is fluidically connected to the inlet of the heat exchanger arranged downstream in the flow direction of the liquid or pressurized CO₂ in the CO₂ connection line, in particular by way of a pipe section that extends transversely, in particular perpendicularly, to the cooling channel longitudinal axis of the cooling channel.

21. The cleaning appliance in accordance with claim 1, wherein the cleaning appliance comprises a CO₂ connection, which is connected or connectable to a CO₂ source, and wherein the CO₂ connection is fluidically connected to the CO₂ connection line.

22. The cleaning appliance in accordance with claim 21, wherein the expansion device comprises a switching device for opening and closing a fluid connection between the CO₂ connection and the expansion chamber inlet, and wherein the switching device is arranged or formed between the cooling device and the expansion chamber inlet.

23. A method for cooling liquid or pressurized CO₂ when supplying to an expansion device, said expansion device being configured to produce CO₂ snow by expanding the liquid or pressurized CO₂ of a cleaning appliance for blasting surfaces to be treated with a mixed stream of a pressurized gas and CO₂ pellets, in particular of a cleaning appliance in accordance with claim 1, wherein the cleaning appliance comprises an apparatus for producing CO₂ pellets from the liquid or pressurized CO₂ wherein the apparatus comprises a compaction device for compacting CO₂ snow to form the CO₂ pellets, wherein the compaction device comprises the expansion device, wherein the liquid or pressurized CO₂ is cooled passively, in particular in counterflow, with gaseous CO₂ exhaust gas that arises during the production of the CO₂ snow and the CO₂ pellets, wherein for cooling the liquid or pressurized CO₂ the CO₂ exhaust gas is conducted through a cooling channel, which is surrounded at least in sections, in particularly completely, by a CO₂ channel in the circumferential direction relative to a direction of extent defined thereby, which CO₂ channel is in thermal contact with the cooling channel and through which the liquid or pressurized CO₂ is guided.

24. The method in accordance with claim 23, wherein the liquid or pressurized CO₂ is expanded before cooling, in particular before or during introduction into the CO₂ channel in thermal contact with the cooling channel, without CO₂ snow forming.
